(19) United States
(12) Patent Application Publication
(10) Pub. No.: US 2006/0277742 A1
(43) Pub. Date: Dec. 14, 2006

(54) Knock-down drums

(76) Inventor: Louis Martin Wentzel, Amanzimtoti (ZA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/543,822

(22) PCT Filed: Dec. 1, 2003
(86) PCT No.: PCT/IB03/05534

§ 371 Date: May 22, 2006

(30) Foreign Application Priority Data
Jan. 28, 2003 (ZA) 2003/0745

(51) Int. Cl. B23P 25/00

(52) U.S. Cl. 29/458; 29/700

(57) ABSTRACT

One aspect of the invention concerns a method of manufacturing the body of a drum kit. The method includes the steps of rolling a flat, unpainted metal sheet (10) to a cylindrical form (12) and welding free edges (14) of the form to produce a cylindrical body (18). This body is temporarily stiffened and paint is applied to the exterior of the temporarily stiffened body. Thereafter the body is destiffened before it is deformed to a suitable shape for nesting with other such bodies. Other aspects of the invention concern the apparatus used in the method and the drum kit itself, including the body and top and bottom ends which can be attached to the respective ends of the body. Yet another aspect of the invention concerns a drum kit body which is of tubular form, which is suitable for nesting with other similar bodies and which has a weld line running from one end of the body to the other. The exterior of the body, including the weld line, is covered by a continuous paint lining applied to the body by a roller spraying operation.

### BACKGROUND TO THE INVENTION

THIS invention relates to a drum body manufacturing method, means and product.

The invention can be applied to the manufacture of bodies of steel drums of 210 l capacity, but it will be understood from the description which follows that the principles of the invention are equally applicable to the manufacture of bodies for drums of different capacity.

Empty steel drums are expensive to transport because of the space which they consume. Thus the cost of steel drums can be high if they are manufactured at a site remote from that at which they are to be filled. To reduce the transportation cost, it has been proposed, in the so-called Sirco drum, to produce drum kits having three separate components, namely a tubular body, a top end and a bottom end. The kit is supplied to the customer who then assembles the drums as required. To save space, the tubular bodies are normally nested one inside the other. The flat top and bottom ends are easily and compactly stacked.

On receipt of the kit, the customer himself assembles the drums in a series of sequential steps. Firstly the drum bodies are denested manually and the bodies are then passed through a rounding machine which restores them to a round cylindrical shape. Thereafter each body is passed through a beader/flanger machine which forms circumferential beads in the body and flanges at the ends of the body.

The body is then passed through a seaming machine which seams the top and bottom ends to the flanged ends of the drum in a seam rolling operation, and which injects a rubber compound into the seam. Finally the assembled drum is tested for leaks.

Conventionally the body of the kit is formed by rolling a flat, pre-painted steel sheet to a round cylindrical form. Company indentification logos and/or other markings are typically screen-printed on the flat pre-painted sheet before it is rolled. The free edges of the round cylindrical form are then welded to one another.

A problem which arises is that the weld is unsightly and destroys the continuity of the originally applied paintwork, possibly requiring a localised touch-up of the paint. This is particularly problematical in situations where the body is painted different colours in different regions along its length, for instance where a central region of the body is to be one colour or carries screen-printed markings and end regions are to be another colour. The end result is invariably unsightly. In situations where one surface of the initial flat sheet is precoated with a rust inhibitor or other treatment, the further problem which arises is that the protection provided by the internal coat is discontinuous at the weld, leading to the possibility of localised internal corrosion in this region if a subsequent step to coat the weld line is not undertaken.

The present invention seeks to address these problems.

### SUMMARY OF THE INVENTION

According to one aspect of the invention there is provided a method of manufacturing the body of a drum kit, the method including the steps of rolling a flat, unpainted metal sheet to a cylindrical form, welding free edges of the form to produce a cylindrical body, temporarily stiffening the cylindrical body, applying paint to the exterior of the temporarily stiffened body, and destiffening the body.

The cylindrical body may be stiffened temporarily during the paint application step by engaging a stiffening form such as a round ring, releasably with one or each end of the body. The paint application step may be carried out at a roller spray station in which the body is arranged with its axis vertical and is rotated, while temporarily stiffened, about that axis relative to one or more paint spray heads which spray paint into the external surface of the body.

According to another aspect of the invention there is provided a method of nesting a plurality of drum bodies manufactured by a method as summarized above, wherein the bodies are in turn deformed to a kidney shape and are slipped, in this shape, one into the other. Preferably each body is deformed to a kidney shape by arranging the body with its axis horizontal and a weld line between the free edges thereof at the top, and pressing downwardly on the body in the region of the weld line.

According to another aspect of the invention there is provided a drum kit comprising a body manufactured by the method summarized above, a drum top attachable to an operatively upper end of the body and a drum bottom attachable to an operatively lower end of the body.

According to yet another aspect of the invention there is provided a drum kit body which is of tubular form, which is suitable for nesting with other similar bodies and which has a weld line running from one end of the body to the other, the exterior of the body, including the weld line, being covered by a continuous paint lining applied to the body by a roller spraying operation.

Further according to the invention there is provided apparatus for manufacturing the body of a drum kit, the apparatus comprising sequence, means for rolling a flat, unpainted metal sheet to a cylindrical form, means for welding free edges of the form to produce a cylindrical body, means for temporarily stiffening the cylindrical body and means for applying paint to the exterior of the temporarily stiffened body. Apparatus may also be provided for deforming the body to a kidney shape suitable for nesting with other such bodies.

Other features of the invention are set forth in the appended claims.

### BRIEF DESCRIPTION OF THE DRAWINGS

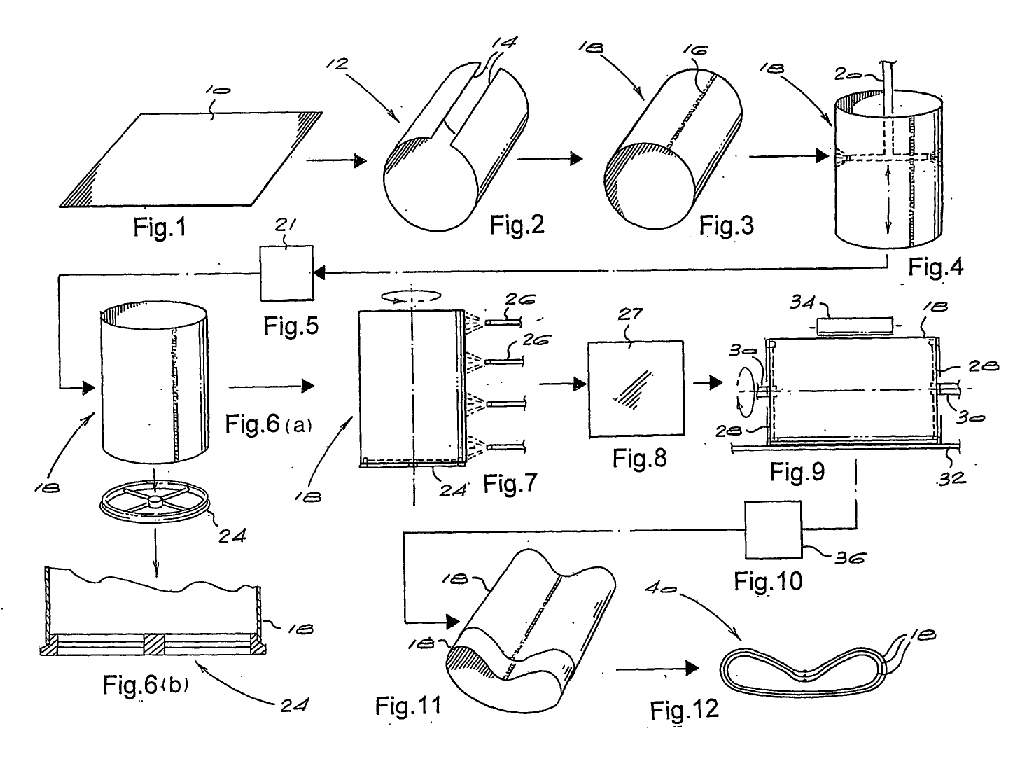

The invention will now be described in more detail, by way of example only, with reference to the accompanying diagrammatic drawings in which FIGS. 1 to 12 depict sequential steps in a method according to one embodiment of the invention.

### DETAILED DESCRIPTION OF THE DRAWINGS

The method of the invention commences with a flat, rectangular mild steel sheet 10 (FIG. 1) which is rolled to a cylindrical form 12 (FIG. 2) by a conventional sheet rolling machine. The free edges 14 of the cylindrical form 12 are then welded to one another at a weld line 16 (FIG. 3), at a welding station, to form a round cylindrical body 18.

Where the internal surface of the body is to be coated with a rust inhibitor or other corrosion resistant or other treatment, the body is then arranged with its central axis upright. At an internal spray station, a spray head apparatus 20 is moved relative to the interior of the body to spray the relevant treatment onto the internal surface of the body (FIG. 4). The body is then passed through an oven 21 (FIG. 5) to cure the internal coating.

At this stage, the body 18 has little ridigity. Its lack of stiffness would make it unsuitable for external roller spray painting. For this reason, the body is temporarily stiffened or rigidified at this stage. As shown in FIGS. 6(a) and 6(b), this is achieved by fitting a stiffening ring 24 as a friction fit into the lower end of the body. This may be achieved manually. If desired, a similar stiffening ring (not shown) may also be fitted to the upper end of the body.

The stiffened body 18 is then passed through a roller spray station in which the body, with its axis upright, is rotated about that axis relative to stationary spray heads 26 which spray paint onto the external surface of the body (FIG. 7). The stiffening ring 24 maintains the cylindrical shape of the body as it is rotated, thereby to ensure accurate and consistent paint application. In the paint application step, different regions of the body may be painted different colours. For instance, upper and lower thirds of the body may be painted one colour and a central third another colour. In such situations, different spray heads apply the different colours and are so designed that there is a clear and accurate break between one colour and the next.

The body is then passed through an oven 27 to cure the external paint (FIG. 8).

Where alphanumerics and/or graphics are to be screen printed on the exterior of the body, the body is arranged with its axis horizontal and is passed through a screen printing station (FIG. 9). At this station stiffening rings 28 are applied to stiffen or rigidify the body. These may be similar to the stiffening ring 24. Preferably, the stiffening rings 28 are carried on shafts 30 forming part of a machine which automatically brings the rings into position in the ends of the body on arrival of the body at the screen printing station on a conveyor 32. The stiffened body is then rotated about its horizontal axis while a screen printing head 34 applies the relevant alphanumerics and/or graphics to the external surface thereof. It will be understood that temporary stiffening of the body is necessary at this stage, in view of the pressure applied to the body by the screen printing head, to maintain the round cylindricality of the body as it is rotated.

After the screen printing head has completed its job, and after the body has passed through a curing oven 36 (FIG. 10) to cure the newly applied paint, the stiffening rings are automatically withdrawn.

As an alternative to a machine which automatically engages stiffening rings or other stiffening means with the ends of the body and then withdraws them after screen printing, the invention envisages a less sophisticated version in which stiffening rings are manually engaged with the ends of the body and are pulled towards one another, for instance by means of an elastic cord extending between them along the axis of the body, prior to entry to the screen printing station. In this case, the rings and cord must be detached manually after screen printing.

After curing of the screen printed alphanumerics and/or graphics in the oven 36 the body is taken to a nesting station. Here the body is deformed to a kidney shape and is slipped lengthwise into another similarly deformed body (FIG. 11). This is achieved, with the axis of the body horizontal, by pressing downwardly on the top of the body, preferably in the vicinity of the weld line 16 which is arranged uppermost, in a suitable press.

As shown in FIG. 12, a substantial number of bodies, each deformed to a kidney shape, can be nested one inside the other for compact transportation.

An important feature of the method as described above is the fact that the step of welding (FIG. 3) is carried out before the body is externally spray painted at the roller spray station (FIG. 7). Welding is also carried out before internal coating (FIG. 4) in situations where an internal coating is in fact applied. This means that the externally sprayed paint and internally applied coating are continuous over the weld line 16. This improves the aesthetics and corrosion resistance of the body and obviates the need for any subsequent touching up operation.

In the nest of bodies 40 (FIG. 12), the bodies locate tightly against one another and there is considerable interference and friction between them both during the nesting operation and during subsequent denesting. For this reason, the paint which is applied at the roller spray station (FIG. 7) should have good scratch resistance. Also, the internally applied coating (FIG. 4) should preferably have low friction capabilities to allow relatively free sliding movement of the bodies relative to one another during nesting and denesting.

Although mention has been made, in relation to FIGS. 1 to 10, of a single body, it will be understood that the steps depicted in these Figures will be carried out on a production line with the body being one of a train of bodies which follow one another on a conveyor system.

In alternative embodiments means other than one or more stiffening rings may be used to rigidify the cylindrical drum body prior to external spray painting. The rigidifying or stiffening means may be incorporated in the spray booth itself. As an example cone-shaped bodies may be inserted automatically into the ends of the body to rigidify it as necessary for painting to take place. The screen printing station may also incorporate automatically inserted rigidifying or stiffening means.

In the above embodiment, the drum body undergoes a first curing step (FIG. 5) after the internal coating is applied at the internal spray station (FIG. 4), a second curing step (FIG. 8) after external spray painting (FIG. 7) and a third curing step (FIG. 10) after screen printing (FIG. 9). To reduce the curing steps, it is within the scope of the invention for the body to be passed through the internal spray station (FIG. 4) and the external spray station, and only then through a single curing oven. After screen printing the body may be passed through a separate curing oven, typically of infra red type. It will be understood that this arrangement eliminates one curing oven.

In one embodiment envisaged by the invention, the drum body is arranged with its axis upright and stiffening means is applied to the lower end of the body at the external spray painting station. The stiffening means at the lower end of the body is driven in rotation to rotate the body. The stiffening means may in this embodiment take the form of a ring or cone which is mounted to a rotatable table and which is applied to the lower end of the body. Alternatively it may be provided by a series of rollers which are arranged in a circular format of variable diameter. As the drum body arrives at the external spray station the rollers are moved upwardly into the lower end of the body. The rollers are carried on a frame which is then expanded radially for the rollers to engage the internal surface of the drum body. The rollers are then rotated to cause rotation of the body while spray paint is applied externally to the body. In practice, where the drum is to have upper and lower bands of one colour and a central band of a different colour, the body may be rotated in a first spray booth at which the upper and lower bands are painted, and thereafter moved to a second spray booth in which the central band is painted. During these steps the upper end of the body may be engaged by a freely rotatable stiffening means such as a ring or cone.

Thereafter the body may be transported, with its lower end still engaged still engaged by the rotatable stiffening means, to an internal spray station at which the internal coating is applied while the body is rotated. As illustrated in FIG. 4, the internal spray head is moved downwardly into the body, so in this case there would be no stiffening means for the upper end of the body.

After the external paint and internal coating have been applied, the drum is demounted from the rotatable table and transported to a curing oven when the paint and coating are cured in a single curing step.

It will be understood that in the embodiment just described, the internal coating step could, as in the illustrated embodiment, be carried out before the external spray painting step.

1-29. (canceled)

30. A method of manufacturing the body of a drum kit, the method including the steps of rolling a flat, unpainted metal sheet to a cylindrical form, welding free edges of the form to produce a cylindrical body, temporarily stiffening the cylindrical body, applying paint to the exterior of the temporarily stiffened body, and destiffening the body.

31. A method according to claim 30 wherein; in the paint application step, the temporarily stiffened cylindrical body is arranged with its axis vertical and is rotated about that axis while paint is sprayed onto the exterior thereof.

32. A method according to claim 31 wherein the body is temporarily stiffened for the paint application step by engaging stiffening means with one or both ends of the body.

33. A method according to claim 32 wherein a stiffening ring is inserted into one or each end of the body to stiffen it temporarily for the paint application step.

34. A method according to claim 30 including the step, after paint is applied to the exterior of the body of screen printing desired alphanumerics and/or graphics onto the externally painted cylindrical surface of the body.

35. A method according to claim 34 wherein the step of screen printing is carried out at a screen printing station at which the body is arranged with its axis horizontal, is temporarily stiffened and is rotated about the axis while a screen printing head acts on the external surface.

36. A method according to claim 35 wherein the body is temporarily stiffened for screen printing by engaging stiffening means with the ends of the body.

37. A method according to claim 36 wherein stiffening rings are engaged with the ends of the body.

38. A method according to claim 36 wherein stiffening cones are engaged with the ends of the body.

39. A method according to claim 30 including the step of internally coating the cylindrical body with a corrosion inhibitor or other suitable treatment.

40. A method according to claim 39 wherein the step of internally coating the body is carried out at an internal coating station at which the cylindrical body is arranged with its axis upright and a coating applicator is moved internally in the body to apply the relevant coating to the internal surface thereof.

41. A method according to claim 40 wherein the body is subjected to curing after application of the internal coating and external paint.

42. A method according to claim 41 wherein the body is subjected to separate curing steps after application of the internal coating and after application of the external paint.

43. A method according to claim 41 wherein the body is subjected to a single curing step after application of the internal coating and external paint.

44. A drum body manufacturing and nesting method comprising the steps of:
providing a plurality of drum bodies in each case by rolling a flat, unpainted metal sheet to a cylindrical form, welding free edges of the form to produce a cylindrical body, temporarily stiffening the cylindrical body, applying paint to the exterior of the temporarily stiffened body, and destiffening the body, and
deforming each body in turn to a kidney shape and slipping it, in this shape, into a previously deformed body while the latter is still in a deformed shape.

45. A method according to claim 44 wherein each body is deformed to a kidney shape by arranging the body with its axis horizontal and a weld line between the free edges thereof at the top, and pressing downwardly on the body in the region of the weld line.

46. A drum kit comprising a body manufactured by rolling a flat, unpainted metal sheet to a cylindrical form, welding free edges of the form to produce a cylindrical body, temporarily stiffening the cylindrical body, applying paint to the exterior of the temporarily stiffened body, and destiffening the body, a drum top attachable to an operatively upper end of the body and a drum bottom attachable to an operatively lower end of the body.

47. A drum body manufactured by the steps of rolling a flat, unpainted metal sheet to a cylindrical form, welding free edges of the form to produce a cylindrical body, temporarily stiffening the cylindrical body, applying paint to the exterior of the temporarily stiffened body, and destiffening the body.

48. A drum body of a drum kit, the drum body being of tubular form being suitable for nesting with other similar bodies and having a weld line running from one end of the body to the other, the exterior of the body, including the weld line, being covered by a continuous paint lining applied to the body by a roller spraying operation.

49. Apparatus for manufacturing the body of a drum kit, the apparatus comprising means for rolling a flat, unpainted metal sheet to a cylindrical form, means for welding free edges of the form to produce a cylindrical body, means for temporarily stiffening the cylindrical body, and means for applying paint to the exterior of the temporarily stiffened body.

50. Apparatus according to claim 49 including means for arranging the body with its axis vertical and for rotating the body about that axis while paint is sprayed onto the exterior thereof.

51. Apparatus according to claim 50 including stiffening means engagable with one or both ends of the body, thereby to stiffen the body temporarily for paint to be sprayed onto the external surface of the body.

52. Apparatus according to claim 51 wherein the stiffening means comprises at least one stiffening ring insertable into an end of the body to stiffen it temporarily.

53. Apparatus according to claim 49 including screen printing means for screen printing desired alphanumerics and/or graphics onto the externally painted, cylindrical surface of the body.

54. Apparatus according to claim 53 including stiffening means engagable with the ends of the body for temporarily stiffening the body during screen printing.

55. Apparatus according to claim 54 wherein the stiffening means comprises stiffening rings or cones engagable with the ends of the body.

56. Apparatus according to claim 49 including means operable, after production of the cylindrical body, to coat the body internally with a corrosion inhibitor or other suitable treatment.

57. Apparatus according to claim 56 including means for arranging the body with its axis upright and a coating applicator which is movable internally in the body to apply the relevant coating to the internal surface of the body.

58. Apparatus according to claim 28 including means for curing the internal coating and external paint.
